(19) United States
(12) Patent Application Publication
(10) Pub. No.: US 2021/0254315 A1
(43) Pub. Date: Aug. 19, 2021

(54) SYSTEM AND METHOD FOR GENERATING WATER FROM AIR

(71) Applicant: ARYAV ECOFRIENDLY RESOURCES PVT. LTD., Gurugram (IN)

(72) Inventor: Sanjay Kumar Garg, Gurugram (IN)

(21) Appl. No.: 17/171,088

(22) Filed: Feb. 9, 2021

(30) Foreign Application Priority Data
Feb. 13, 2020 (IN) 202011006213

(51) Int. Cl. E03B 3/28; C02F 1/00

(52) U.S. Cl. CPC E03B 3/28; C02F 1/283; C02F 1/003

(57) ABSTRACT

The invention relates to a system 100 and method 200 for generating water from air. The system 100 includes a housing 102 having an inlet 108 and an outlet 110. The air is drawn into the housing 102 via at least one fan 112. A first heat exchanger unit 118 cools the air via peltier effect. A second heat exchanger unit 124, operating independent of the first heat exchanger unit 118, condenses the air flowing across the first heat exchanger unit 118. The condensed water is collected in a primary tank 128. A filtration system 134 filters the water collected in the primary tank 128. The system 100 includes a pumping unit 136 to pump the filtered water from the primary tank 128 to the at least one secondary tank 138. A dispenser 140, powered by a battery 142, dispenses the water from each of the at least one secondary tank 138.

### FIELD

The present invention generally relates to a system for generating water, and more particularly, the present invention relates to a system and method for generating water from air by extracting water vapour from air.

### BACKGROUND

The availability of water has been identified as one of the major problems for mankind in the future. With the rapid increase in human population, and the effects of long term climate change, it is foreseen that drinking water will become scarce in the near future.

In order to overcome the problem of water scarcity, governments have initiated several projects on development of infrastructures to either recycle water or to create drinking water from non-potable water supplies. Furthermore, a large number of desalination plants are currently being set up, where the sea water is desalinated to convert into drinking water.

Even though such measures are creating a positive effect, the desalination and water recycling plants are quite expensive to build. Further, such desalination and recycling plants incur high operating costs as they are known to require significant amounts of electricity to operate.

Hence, there is a need for new and improved system and method that can reliably generate significant quantities of drinking water and are even economical to operate.

### SUMMARY

In an embodiment, a system for generating water from air is disclosed. The system includes a housing having an inlet for receiving the air, and an outlet for exhausting the air. The air is drawn into the housing via at least one fan mounted on the inlet of the housing. A first heat exchanger unit arranged in proximity to the inlet may cool the air drawn by the at least one fan via peltier effect. The system further includes a second heat exchanger unit for condensing the air flowing across the first heat exchanger unit. The second heat exchanger unit may be operable independent to the first heat exchanger unit. The water condensed by the second heat exchanger unit is collected in a primary tank that is arranged below the second heat exchanger unit. The system further includes a filtration system for filtering the condensed water collected in the primary tank. The filtered water from the primary tank is collected in at least one secondary tank. The system further includes a pumping unit to pump the water from the primary tank to the at least one secondary tank. The system further includes a dispenser for dispensing the water from the at least one secondary tank where the dispenser is powered by a battery and may dispense water even during power outage.

In another embodiment, a method for generating water from air is disclosed. The method includes a step of receiving the air. The method further includes a step of cooling the air via a first heat exchanger unit. The first heat exchanger unit cools the air by peltier effect. The method further includes a step of condensing the air into water via a second heat exchanger unit. On condensing the water, the method includes a step of collecting the condensed water in a primary tank. The method further includes a step of filtering the water collected in the primary tank and pumping the filtered water in at least one secondary tank. The pumping of the filtered water from the primary tank to the at least one secondary tank is achieved by a pumping unit. The method further includes a step of dispensing the water from the at least one secondary tank where the dispenser is powered by a battery.

It is to be understood that both the foregoing general description and the following detailed description are exemplary and explanatory only and are not restrictive of the invention, as claimed.

### BRIEF DESCRIPTION OF THE DRAWINGS

In order that the advantages of certain embodiments of the invention will be readily understood, a more particular description of the invention briefly described will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a schematic diagram of a system for generating water from air according to an exemplary embodiment of the invention;

FIG. 2 illustrates an exploded view of the system for generating water from the air according to an exemplary embodiment of the invention;

FIG. 3 is illustrates a perspective view of a first compartment of the system for generating water from the air according to an exemplary embodiment of the invention;

FIG. 4 illustrates a side view of the opened first compartment of the system for generating water from the air according to an exemplary embodiment of the invention;

FIG. 5 illustrates a front view of an air filter according to an exemplary embodiment of the invention;

FIG. 6 illustrates a perspective view of a compressor according to an exemplary embodiment of the invention;

FIG. 7 illustrates a perspective view of a primary tank according to an exemplary embodiment of the invention;

FIG. 8 illustrates a top perspective view of the primary tank according to an exemplary embodiment of the invention;

FIG. 9 illustrates a front view of a filtration system according to an exemplary embodiment of the invention; and

FIG. 10 illustrates a flowchart of a method for generating water from air according to another exemplary embodiment of the invention.

### DETAILED DESCRIPTION OF THE EMBODIMENTS

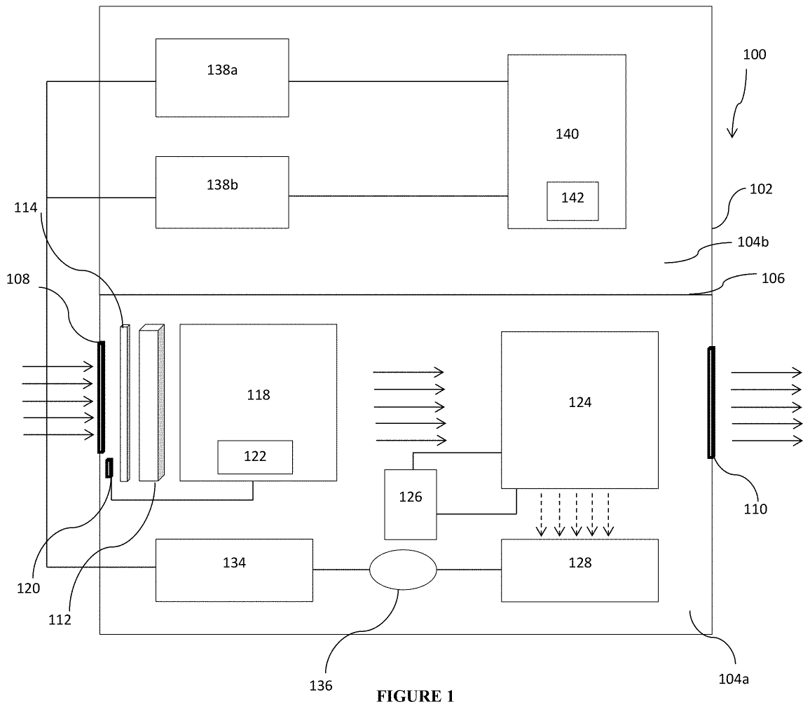

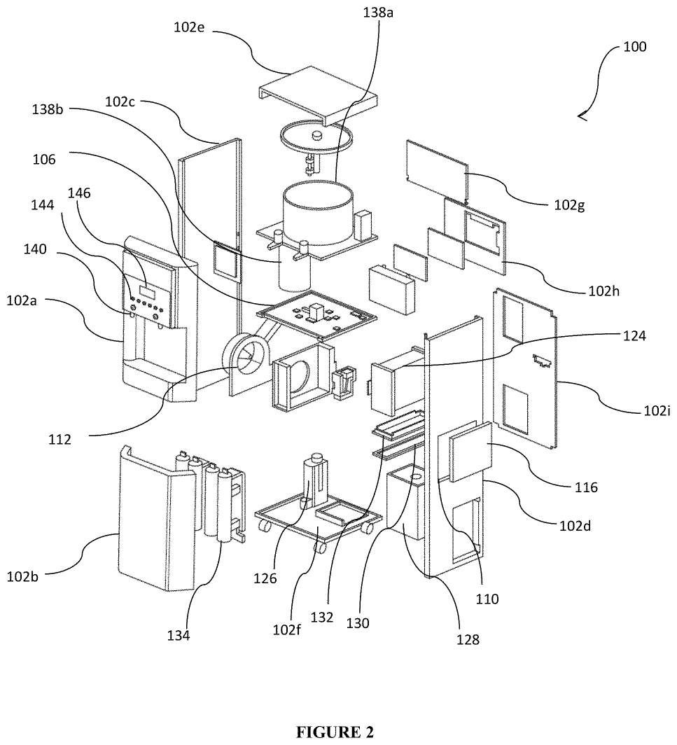

Referring now to FIG. 1 and FIG. 2, a schematic diagram and an exploded view respectively of a system 100 for generating water from air is illustrated in accordance with an exemplary embodiment of the invention. It should be noted that the words ‘air’ and ‘ambient air’ may be used interchangeably in the description without limiting the scope of the invention in any way. The system 100 for generating water from air (hereinafter referred to as system) may be employed in an area in order to generate water from the ambient air of that area. The system 100 generates water by extracting the water vapour present in the air. In other words, the system 100 generates water by condensing the water vapour present in the air. Therefore, it will be understood by a person skilled in the art that the system 100 may work in areas where the ambient air holds water vapour. In other words, the system 100 may work in areas where the relative humidity is above 30%. The system 100 may be usually employed in areas where there is lack of availability of drinking water. However, it will be appreciated by a person skilled in the art that the system 100 may be employed in any area. It should be noted that the system 100 may be capable of generating water in areas where the temperature range of the ambient air is within 15° C.-50° C.

The system 100 for generating water from the air includes a housing 102. The housing 102 forms the protective outer covering of the system 100 and accommodates the components of the system 100. In an embodiment, the housing 102 may have a first compartment 104a and a second compartment 104b. By way of an example, the first compartment 104a may be a lower compartment and the second compartment 104b may be an upper compartment. The first compartment 104a and the second compartment 104b may be separated via a partition 106. For the purpose of explanation, the partition 106 may be a plate arranged within the housing 102 that separates the housing 102 into the first compartment 104a and the second compartment 104b. It should be noted that the second compartment 104b may be removable from the first compartment 104a. In certain embodiments, the housing 102 may be a bare shell without any partition 106.

The housing 102 may be formed by assembling a plurality of panels. By way of an example, the housing 102 may include a front upper panel 102a, a front lower panel 102b, a left panel 102c, a right panel 102d, a top panel 102e, a bottom panel 102f, a rear upper panel 102g, a rear middle panel 102 h and a rear lower panel 102i. It will be apparent to a person skilled in the art that the configuration and arrangement of the panels may vary depending on the design of the system 100. Further, the panels may be assembled to each other via one or more fastening means and may be removable as and when required by a user.

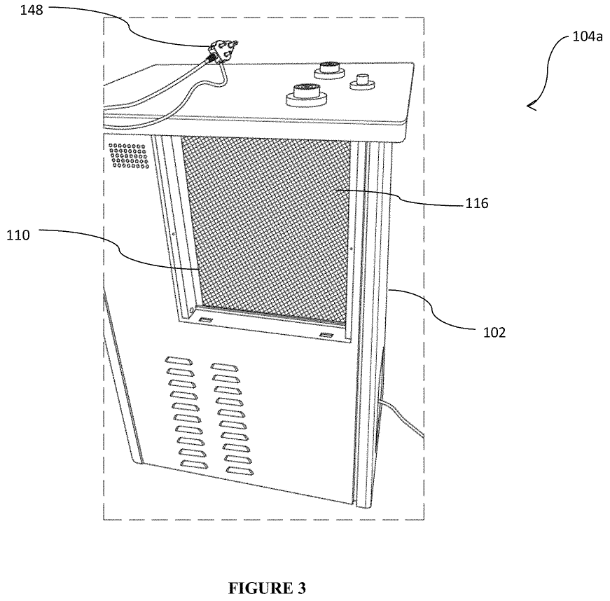

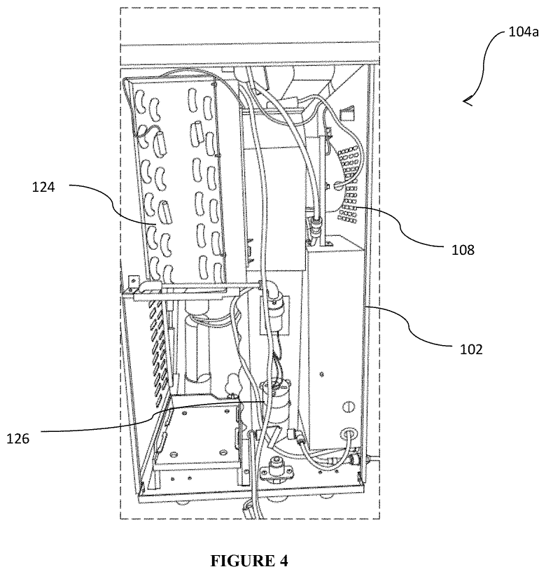

Referring now to FIG. 3 and FIG. 4, a perspective view and an opened side view respectively of the first compartment 104a of the housing 102 is illustrated in accordance with an exemplary embodiment of the invention. The housing 102 includes an inlet 108 for receiving the air into the housing 102. In an embodiment, the inlet 108 may be an opening on at least one of the panels of the housing 102. In another embodiment, the inlet 108 may be a plurality of openings on the at least one of the panels of the housing 102. It will be apparent to a person skilled in the art that the count, shape and size of the opening may vary depending on the design of the system 100. The housing 102 further includes an outlet 110 for exhausting the air out of the housing 102. In an embodiment, the outlet 110 may be an opening on at least one of the panels of the housing 102. In another embodiment, the outlet 110 may be a plurality of openings on the at least one of the panels of the housing 102. It will be apparent to a person skilled in the art that the count, shape and size of the opening may vary depending on the design of the system 100. In an implementation, the inlet 108 and the outlet 110 may be provided on the opposite panels. By way of an example, the inlet 108 may be provided on the left panel 102c and the outlet 110 may be provided on the right panel 102d. It will be understood by a person skilled in the art that the inlet 108 and the outlet 110 on the opposite panels may facilitate the flow of air from the inlet 108 to the outlet 110.

The system 100 includes at least one fan 112 mounted on the inlet 108 for drawing the air into the housing 102. In an embodiment, the fan 112 may draw the air directly through the inlet 108. In another embodiment, the fan 112 may draw the air through a spiral casing extending from the inlet 108 to the fan 112. It will be understood by a person skilled in the art, that the fan 112 may be arranged with respect to the inlet 108 in such a manner that the fan 112 constantly draws air into the housing 102 when turned on. In certain embodiments, the fan 112 speed may be controlled via a controller. In certain scenarios where the ambient air is already blowing at high speed, the system 100 may be operated even with the fan 112 turned off. In several embodiments, the system 100 may include at least one fan mounted on the outlet 110 for exhausting the air out of the housing 102. It will be understood by a person skilled in the art that the fans on the inlet 108 and the outlet 110 may accelerate the air flow movement from the inlet 108 to the outlet 110 thereby enabling the system 100 to extract more water from the air.

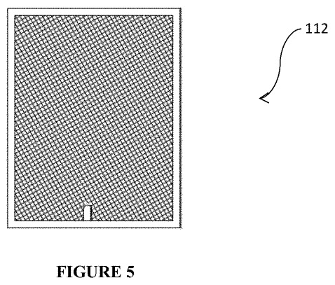

According to an embodiment, the housing 102 may include an air filter 114. Referring now to FIG. 5, a front view of the air filter 114 is illustrated in accordance with an exemplary embodiment of the invention. The air filter 114 may be arranged on the inlet 108 and may prevent any foreign particles to enter into the housing 102. The particles, for example, may include dust, dirt, smoke, soot, liquid droplets or any other particles known in the art. It will be understood by a person skilled in the art that the air filter 114 may filter the air entering into the housing 102.

Further, in several embodiments, the housing 102 may include a ventilation grid 116. The ventilation grid 116 may be arranged on the outlet 110 and may allow the air to flow out of the housing 102. It will be apparent to a person skilled in the art that the air flowing from the outlet 110 may be the air from which, either partially or wholly, the water vapour has been extracted.

The system 100 further includes a first heat exchanger unit 118. In several embodiments, the first heat exchanger unit 118 may be arranged in proximity to the inlet 108. The first heat exchanger unit 118 may be arranged to cool the air flowing through the inlet 108. It should be noted that the first heat exchanger unit 118 may operate only if the temperature of the ambient air is above a predefined temperature. In other words, if the ambient air is cool or if the temperature of the ambient air is below a predefined temperature, the first heat exchanger unit 118 may not be operated.

In certain embodiments, the temperature of the ambient air may be monitored by a thermostat 120 arranged at the inlet 108. Further, based on the temperature of the ambient air, the thermostat 120 may control the operation of the first heat exchanger unit 118. It will be apparent to a person skilled in the art that the predefined temperature may be manually set and modified by the user as and when required.

The first heat exchanger unit 118 may cool the air via peltier effect. The first heat exchanger unit 118 may include a peltier module 122 thermally communicated to the first heat exchanger unit 118. The peltier module 122 may be arranged on the first heat exchanger unit 118 in such a manner that a cooling side of the peltier module 122 is in communication with the first heat exchanger unit 118 and a heating side of the peltier module 122 may release the heat into the atmosphere. In certain embodiments, a heat sink may be attached to the heating side of the peltier module 122 for facilitating the heat dissipation. It will be apparent to a person skilled in the art that on powering the peltier module 122, the cooling side may cool the first heat exchanger unit 118.

The system 100 further includes a second heat exchanger unit 124. The second heat exchanger unit 124 may condense the air flowing across the first heat exchanger unit 118 and towards the outlet 110. In an embodiment, the second heat exchanger unit 124 may condense the air cooled by the first heat exchanger unit 118. In another embodiment, the second heat exchanger unit 124 may directly condense the air entering the housing 102. For the purpose of explanation, the second heat exchanger unit 124 directly condenses the air in scenarios where the temperature of the air is below the predefined temperature. Further, it should be noted that the second heat exchanger unit 124 may be operable independent to the first heat exchanger unit 118.

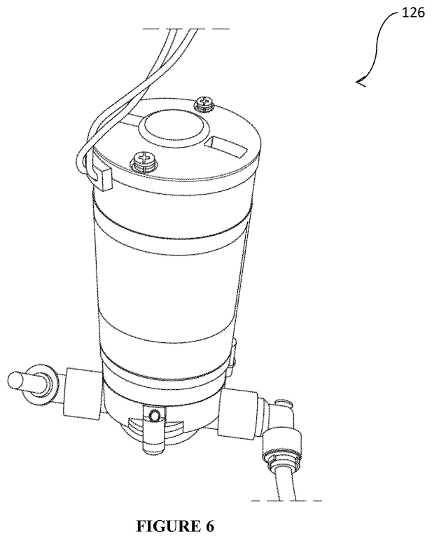

The second heat exchanger unit 124 may include a condenser and an evaporator. The condenser and the evaporator may be fluidly connected to a compressor 126. In other words, the condenser, the evaporator and the compressor 126 may form a fluid circuit that circulates a refrigerant. FIG. 6 illustrates a perspective view of the compressor 126 in accordance with an exemplary embodiment of the invention. The refrigerant flowing within the fluid circuit may get compressed in the compressor 126 and may condense the air at the second heat exchanger unit 124. In an embodiment, the compressor 126 may include double insulation. In other words, the compressor 126 may be a double walled compressor. The double walled compressor 126 may enable the system 100 to generate water even at high ambient temperatures.

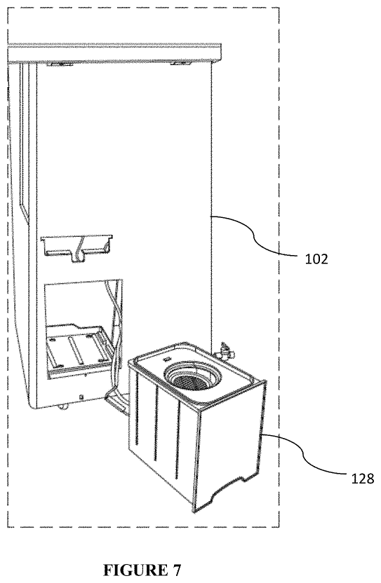

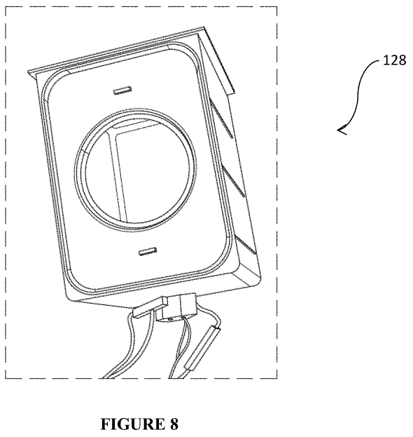

The system 100 further includes a primary tank 128. Referring now to FIG. 7 and FIG. 8, a perspective view and a top view respectively of the primary tank 128 is illustrated in accordance with an exemplary embodiment of the invention. The primary tank 128 may collect the water condensed by the second heat exchanger unit 124. In an embodiment, the primary tank 128 may be arranged below the second heat exchanger unit 124. In certain implementations, the system 100 may include a water tray 130 arranged below the second heat exchanger unit 124. The water generated after condensation may be collected in the primary tank 128 via the water tray 130. The water tray 130 may be arranged below the second heat exchanger unit 124 through a water tray support 132. It will be apparent to a person skilled in the art that the shape and configuration of the primary tank 128 may vary depending on the design of the system 100. Further, in certain implementations, the primary tank 128 may be removable from an opening provided on one of the panels.

In an embodiment, the primary tank 128 may rest on the bottom panel 102f of the housing 102. In another embodiment, the primary tank 128 may be arranged external to the housing 102. It will be apparent to a person skilled in the art that the arrangement of the primary tank 128 may vary depending on the design of the system 100. It will be further apparent to a person skilled in the art that the capacity of the primary tank 128 may vary depending on the water generation capacity of the system 100.

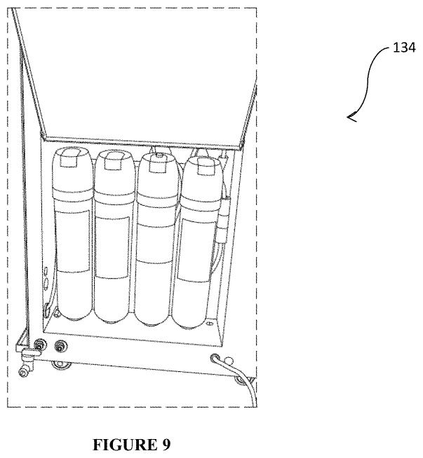

The system 100 further includes a filtration system 134 for filtering the water collected in the primary tank 128. Referring now to FIG. 9, a front view of the filtration system 134 is illustrated in accordance with an exemplary embodiment of the invention. The filtration system 134 is preferably a multi-stage system. The filtration system 134 preferably removes any microbes present in the water and adds minerals to the water to improve drinkability. In an embodiment, the filtration system 134 may include a sediment filter. In another embodiment, the filtration system 134 may include a pre-carbon filter. In yet another embodiment, the filtration system 134 may include a post-carbon filter. In yet another embodiment, the filtration system 134 may include an ultraviolet filter. In yet another embodiment, the filtration system 134 may include one or more of the filters from the abovementioned embodiments.

The system 100 further includes a pumping unit 136. The pumping unit 136 may be configured to pump water from the primary tank 128 to an at least one secondary tank 138. It will be apparent to a person skilled in the art that the pumping capacity of the pumping unit 136 may vary depending on the water generation capacity of the system 100.

In an implementation, the fan 112, the first heat exchanger unit 118, the second heat exchanger unit 124, the compressor 126, the primary tank 128, the filtration system 134 and the pumping unit 136 may be arranged in the first compartment 104a.

The secondary tank 138 may be arranged in the second compartment 104b of the housing 102. The secondary tank 138 may receive the filtered water from the primary tank 128. In an embodiment, the system 100 may include a single secondary tank 138. In another embodiment, the system 100 may include two secondary tanks. For the purpose of explanation, the secondary tanks 138 may include a cold tank 138a and a hot tank 138b. Each of the secondary tanks 138 may be connected to the primary tank 128 via at least one conduit. In an embodiment, the primary tank 128 may be directly connected to each of the secondary tanks 138. In another embodiment, the primary tank 128 may be connected to one of the secondary tanks 138a that further transfers fluid to other secondary tanks 138b. It will be apparent to a person skilled in the art that the cold tank 138a and the hot tank 138b may include means for cooling and heating the respective secondary tanks 138.

The system 100 further includes a dispenser 140. The dispenser 140 may be connected to each of the secondary tanks 138. By way of an example, the dispenser 140 may dispense cold water from the cold tank 138a and hot water from the hot tank 138b. The dispenser 140 may be powered by a battery 142. In other words, the dispenser 140 may be a battery operated dispenser. It will be apparent to a person skilled in the art that the dispenser 140 may be operated even during a power outage. For the purpose of explanation, the battery 142 for powering the dispenser 140 may be a small battery such as a lead-acid battery, a nickel-cadmium battery, a lithium-ion battery or a lithium-ion phosphate battery.

The system 100 further includes a controller to monitor one or more parameters of the system 100. The controller may be an input/output controller where the user may input information for operating the system 100. The user may input the information via a keyboard 144 arranged on the system 100. In certain embodiments, the controller may receive input information from one or more sensors arranged in the system 100 for monitoring various parameters of the system 100.

The system 100 further includes a display unit 146 to display information related to the parameters of the system 100. The display unit 146 may display information on system operation parameters as well as water collection data. For the purpose of explanation, the system operation parameters may include features such as time, date, humidity of air, and temperature of air. Water collection data may include data such as water already generated, water to be generated, water available in the primary tank 128 and water available in each of the secondary tanks 138.

In a preferred embodiment, the system 100 may be a portable system and have a compact structure. In order to achieve the compact structure, the second compartment 104b may be vertically aligned on top of the first compartment 104a. Further, wheels, handle, or other components may also affixed to the housing 102 to aid in the portability of the system 100. In another embodiment, the system 100 may be a heavy system and have a large structure. It will be understood by a person skilled in the art that in such embodiments, the system 100 may be fixed and may not be portable. Further, the system 100 may be powered by an alternating current (AC) and may have a power plug 148.

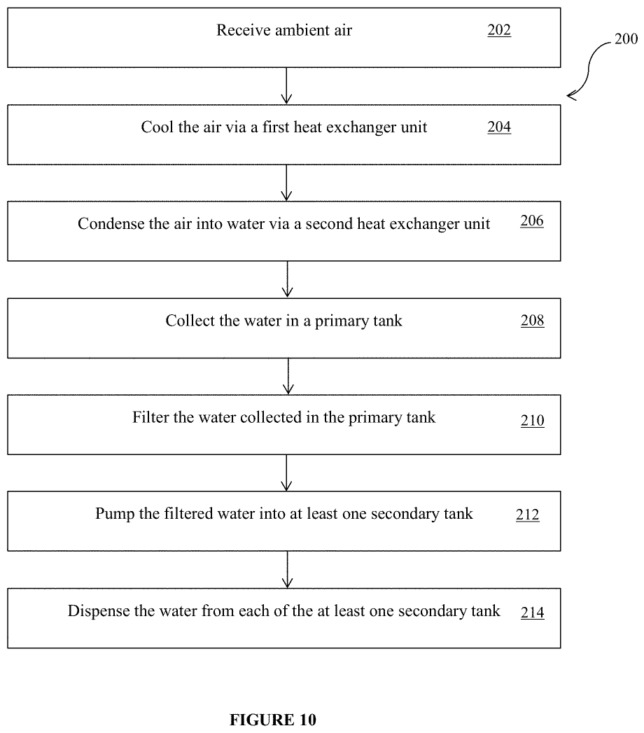

Referring now to FIG. 10, a flowchart of a method 200 for generating water from air is illustrated in accordance with another exemplary embodiment of the invention. The method includes a step 202 of receiving the air. The air may be ambient air having water vapour. In other words, the air may be humid in nature. The air is received into a housing of a system for generating water from air. It should be noted that the air received into the housing may be filtered and any foreign particles present in the air may be removed therein. In an embodiment, the air may be filtered by an air filter.

The method further includes a step 204 of cooling the air via a first heat exchanger unit. The ambient air entering the housing flows across the first heat exchanger unit. The first heat exchanger unit is a peltier based heat exchanger and cools the air via a peltier effect. It should be noted that the cooling of the air via the first heat exchanger unit may be performed depending on the temperature of the air. For example, if the temperature of the air is above a predefined temperature, the air is cooled by the first heat exchanger unit and if the temperature of the air is below the predefined temperature, the air is not cooled by the first heat exchanger unit. In other words, the first heat exchanger unit is operated based on the temperature of the ambient air.

The method further includes a step 206 of condensing the air via a second heat exchanger unit. The air flowing across the first heat exchanger unit may flow towards the second heat exchanger unit. In an embodiment, the second heat exchanger unit may condense the air cooled by the first heat exchanger unit. In another embodiment, the second heat exchanger unit may directly condense the ambient air without being cooled by the first heat exchanger unit.

The method further includes a step 208 of collecting the condensed water in a primary tank. The air after being condensed into water may be collected from the second heat exchanger unit. The primary tank may be placed below the second heat exchanger unit for collecting the condensed water. In an embodiment, the condensed water is directly collected in the primary tank. In another embodiment, the condensed water is collected in the primary tank via a water tray. It will be apparent to a person skilled in the art that the condensed water collected in the primary tank may not be in a filtered state.

The method further includes a step 210 of filtering the water collected in the primary tank. The water is filtered by a filtration system arranged within the system for generating water from air.

The method further includes a step 212 of pumping the filtered water from the primary tank to an at least one secondary tank. The water may be pumped via a pumping unit. The water while getting pumped from the primary tank to the secondary tank may undergo filtration.

The method further includes a step 214 of dispensing water from each of the secondary tanks. The dispensing of the water may be achieved by a dispenser. In an embodiment, the dispenser may be powered by a battery. It should be noted that dispenser may be capable of dispensing water even during a power outage.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A system 100 for generating water from air, the system 100 comprising:
a housing 102 having an inlet 108 for receiving the air, and an outlet 110 for exhausting the air;
at least one fan 112 mounted on the inlet 108 for drawing the air into the housing 102;
a first heat exchanger unit 118 for cooling the air drawn by the at least one fan 112, wherein the first heat exchanger unit 118 cools the air via peltier effect;
a second heat exchanger unit 124 for condensing the air flowing across the first heat exchanger unit 118, wherein the second heat exchanger unit 124 is operable independent of the first heat exchanger unit 118;
a primary tank 128 arranged below the second heat exchanger unit 124 for collecting the condensed water;
a filtration system 134 for filtering the condensed water collected in the primary tank 128;
at least one secondary tank 138 for receiving the filtered water from the primary tank 128;
a pumping unit 136 to pump the water from the primary tank 128 to the at least one secondary tank 138; and
a dispenser 140 for dispensing the water from each of the at least one secondary tank 138, wherein the dispenser 140 is powered by a battery 142.

2. The system 100 for generating water from the air as claimed in claim 1, wherein the first heat exchanger unit 118 comprises a peltier module 122.

3. The system 100 for generating water from the air as claimed in claim 1, wherein the first heat exchanger unit 118 cools the air if the temperature of the air is above a predefined temperature.

4. The system 100 for generating water from the air as claimed in claim 1, wherein the system 100 further comprises a compressor 126 for circulating a refrigerant to the second heat exchanger unit 124.

5. The system 100 for generating water from the air as claimed in claim 4, wherein the compressor 126 is a double insulation compressor.

6. The system 100 for generating water from the air as claimed in claim 1, wherein the system 100 further comprises a controller and a display unit 146 to monitor one or more parameters of the system 100.

7. The system 100 for generating water from the air as claimed in claim 1, wherein the filtration system 134 comprises at least one of a sediment filter, a pre-carbon filter, a post-carbon filter or an Ultraviolet filter.

8. The system 100 for generating water from the air as claimed in claim 1, wherein the secondary tank 138 is at least one of a cold tank 138a or a hot tank 138b.

9. The system 100 for generating water from the air as claimed in claim 1, wherein the primary tank 128 is connected to each of the at least one secondary tank 138 via a conduit.

10. A method 200 for generating water from air, the method comprising:
receiving 202 the air;
cooling 204 the air via a first heat exchanger unit, wherein the first heat exchanger unit cools the air by peltier effect;
condensing 206 the air into water via a second heat exchanger unit;
collecting 208 the condensed water in a primary tank;
filtering 210 the water collected in the primary tank;
pumping 212 the filtered water to at least one secondary tank; and
dispensing 214 the water from each of the at least one secondary tank, wherein the dispenser is powered by a battery.
